(19) United States
(12) Patent Application Publication
(10) Pub. No.: US 2018/0130475 A1
(43) Pub. Date: May 10, 2018

(54) METHODS AND APPARATUS FOR BIOMETRIC AUTHENTICATION IN AN ELECTRONIC DEVICE

(71) Applicant: Cirrus Logic International Semiconductor Ltd., Edinburgh (GB)

(72) Inventors: Michael PAGE, Gloucestershire (GB); Ryan ROBERTS, Hertfordshire (GB)

(73) Assignee: Cirrus Logic International Semiconductor Ltd., Edinburgh (GB)

(21) Appl. No.: 15/804,641

(22) Filed: Nov. 6, 2017

Related U.S. Application Data
(60) Provisional application No. 62/418,453, filed on Nov. 7, 2016.

(30) Foreign Application Priority Data
Dec. 20, 2016 (GB) 1621721.8

(51) Int. Cl. G10L 17/22; G10L 15/18; G10L 17/06; G10L 25/84; G06F 21/32

(52) U.S. Cl. CPC G10L 17/22; G10L 15/1815; H04M 1/673; G10L 25/84; G06F 21/32; G10L 17/06

(57) ABSTRACT

Embodiments of the disclosure provide methods and apparatus in which a biometric authentication score generated as the result of a biometric authentication algorithm is compared to a threshold value that can be dynamically varied as required to provide a variable level of security. For example, the threshold value may be varied in dependence on the semantic content of a voice signal, and/or the context in which the voice signal was acquired. Authentication of the signal may be initiated in parallel with speech recognition, such that the appropriate threshold value is only determined after authentication has already begun.

### TECHNICAL FIELD

Examples of the present disclosure relate to methods and apparatus for biometric authentication in an electronic device, and particularly relate to methods and apparatus for authenticating the voice of a user of an electronic device.

### BACKGROUND

The growing demand for more secure, more reliable and more convenient user authentication solutions for mobile devices is accepted and publicized in the industry.

It is expected that biometrics will replace passwords, particularly on mobile platforms, as long passwords are difficult to remember and difficult to type on such devices. For example, in order to improve user experience, many manufacturers of mobile phones have embedded fingerprint sensors in their recent devices, and it is expected that users will increasingly adopt biometrics in order to access their device and/or specific functions thereon. Other types of biometric authentication include iris recognition and voice recognition. Multiple different types of authentication (e.g. passwords, fingerprint/iris/voice recognition, etc) may be combined in order to increase the security of a particular operation.

Two barriers to the uptake of biometric authentication in the industry are the requirements that the authentication process should provide a high level of security, while still being easy to use.

For example, users of electronic devices such as smartphones and the like demand that their devices operate correctly time after time. In the field of biometric authentication, this manifests itself in a desire that the device should not reject an attempt at biometric authentication if the user is indeed an authorised user of the device, i.e. the device should not falsely reject an authorised user. Each false rejection will only serve to irritate the user, and thus the false rejection rate (FRR) of the biometric authentication process should be low.

Conversely, biometric authentication is typically used to secure a process or function within the device that requires some level of authorisation, and to which non-authorised users should not be allowed access. For example, biometric authentication may be employed to control access to the device (i.e. unlocking the device from a locked state), or to provide authorisation for a financial transaction initiated by the electronic device. Thus the biometric authentication should not authenticate users who are not authorised users of the device; the false acceptance rate (FAR) should also be low.

The problem is that these requirements conflict with each other. Biometric authentication involves a comparison of one or more aspects of biometric input data (e.g. speech, fingerprint image data, iris image data, etc) with corresponding aspects of stored biometric data that is unique to authorised users (e.g. users who have undergone an enrolment process with the device). The output of the biometric authentication algorithm is a score indicating the level of similarity between the input data and the stored data. The precise values used may be defined in any manner; however, for convenience we will assume herein that the score may vary between values of 0 (to indicate absolute confidence that the biometric input does not originate from an authorised user) and 1 (to indicate perfect similarity between the biometric input data and the stored data).

In practice, the biometric input data will rarely or never reach the limits of the range of values, even if the biometric input data originated from an authorised user. Therefore a designer of the biometric authentication process generally assigns a predetermined threshold value (that is lower than unity), scores above which are taken to indicate that the biometric input data is from an authorised user. In order to improve reliability (i.e. a low FRR), the designer may wish to set this threshold relatively low so that genuine users are not falsely rejected. However, a low threshold increases the likelihood that a non-authorised user will be falsely authenticated, i.e. the FAR will be relatively high.

FIG. 1 is a schematic diagram showing this typical relationship between FRR and FAR as the threshold varies. Note that the illustrated relationship is approximate and intended only to illustrate the basic principles involved. As FAR is lowered, the FRR increases and vice versa. The particular operating point on the FAR-FRR relationship is chosen by altering the threshold value. A relatively high threshold value leads to a relatively low FAR but a relatively high FRR; a relatively low threshold value leads to a relatively low FRR but a relatively high FAR.

FIG. 1 also shows the variation of the FAR-FRR relationship when the efficacy of the authentication algorithm is degraded due to changes in operating conditions (e.g. because of increased noise in the biometric input signal, or increased distance between the user and the input device capturing the biometric input). Take the solid line as a starting point. As the performance of the authentication process becomes worse, the relationship moves outwards in the direction of the arrow, towards the dashed line. Both FAR and FRR are increased for a given threshold value.

### SUMMARY

Conventionally, the conflicting requirements between reliability and security have been resolved by configuring biometric authentication systems for a specific and fixed FAR, in order to achieve a specified (high) level of security. However, different commands and user operations may have differing requirements for security. The required level of security may also be affected by other context information, such as the environment and circumstances the user is in. For example, in a car, the acoustic conditions (very high noise level) are likely to impair reliability, whereas the required security may be relatively benign (as the car is a private environment). In that situation it may be appropriate to perform authentication with an operating point of reduced security and enhanced reliability in order to achieve a level of reliability that is useful to the user.

According to one aspect of the disclosure, there is provided a method of carrying out biometric authentication of a speaker, the method comprising: receiving a voice data signal comprising data corresponding to a voice of the speaker; performing a biometric authentication algorithm on the voice data signal, the biometric authentication algorithm comprising a comparison of one or more features in the voice data signal with one or more stored templates corresponding to a voice of an authorised user, and being configured to generate a biometric authentication score; receiving a control signal comprising an indication of one or more of a false acceptance rate and a false rejection rate; determining one or more thresholds based on the one or more of the false acceptance rate and the false rejection rate; and comparing the biometric authentication score with the one or more threshold values to determine whether the speaker corresponds to the authorised user.

Another aspect of the disclosure provides a biometric authentication system for authentication of a speaker, comprising: a biometric signal processor, configured to perform a biometric authentication algorithm on a voice data signal, the voice data signal comprising data corresponding to a voice of the speaker, the biometric authentication algorithm comprising a comparison of one or more features in the voice data signal with one or more stored templates corresponding to a voice of an authorised user, and being configured to generate a biometric authentication score; an input, configured to receive a control signal comprising an indication of one or more of a false acceptance rate and a false rejection rate; logic circuitry configured to determine the one or more threshold values based on the one or more of the false acceptance rate and the false rejection rate; and comparison logic, for comparing the biometric authentication score with the one or more thresholds to determine whether the speaker corresponds to the authorised user.

An electronic device comprising the biometric authentication system described above is also provided.

A further aspect of the present disclosure provides a method in an electronic device, comprising: acquiring a voice data signal corresponding to a voice of a user of the electronic device; initiating a speech recognition algorithm to determine a content of the voice data signal; determining a security level associated with the content of the voice data signal; determining a context of the electronic device when the voice data signal was acquired; and providing an indication of one or more thresholds to a biometric authentication system, for use in determining whether the user is an authorised user of the electronic device, wherein the indication of one or more thresholds is determined in dependence on the security level associated with the content and the context of the electronic device when the voice data signal was acquired, wherein the context is determined in dependence on one or more of: a geographical location of the electronic device; a velocity of the electronic device; an acceleration of the electronic device; a level of noise in the voice data signal; one or more peripheral devices to which the electronic device is connected; and one or more networks to which the electronic device is connected.

In another aspect, there is provided a signal processor, for use in an electronic device, the signal processor comprising: an input, configured to receive a voice data signal corresponding to a voice of a user of the electronic device; a speech recognition interface, for initiating a speech recognition algorithm to determine a content of the voice data signal; logic circuitry, for determining a security level associated with the content of the voice data signal, and for determining a context of the electronic device when the voice data signal was acquired; and an output interface, for providing an indication of one or more thresholds to a biometric authentication system, for use in determining whether the user is an authorised user of the electronic device, wherein the indication of one or more thresholds is determined in dependence on the security level associated with the content and the context of the electronic device when the voice data signal was acquired, and wherein the context is determined in dependence on one or more of: a geographical location of the electronic device; a velocity of the electronic device; an acceleration of the electronic device; a level of noise in the voice data signal; one or more peripheral devices to which the electronic device is connected; and one or more networks to which the electronic device is connected.

An electronic device comprising the signal processor described above is also provided.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a schematic diagram showing the relationship between false acceptance rate (FAR) and false rejection rate (FRR) in a biometric authentication process;

FIG. 2 shows an electronic device according to embodiments of the disclosure;

FIG. 3 is a flowchart of a method according to embodiments of the disclosure;

FIG. 4 is a flowchart of another method according to embodiments of the disclosure;

FIG. 5 illustrates the processing of voice input according to embodiments of the disclosure;

FIG. 6 illustrates the processing of voice input according to further embodiments of the disclosure; and

FIG. 7 is a timing diagram showing the processing of voice input according to embodiments of the disclosure.

### DETAILED DESCRIPTION

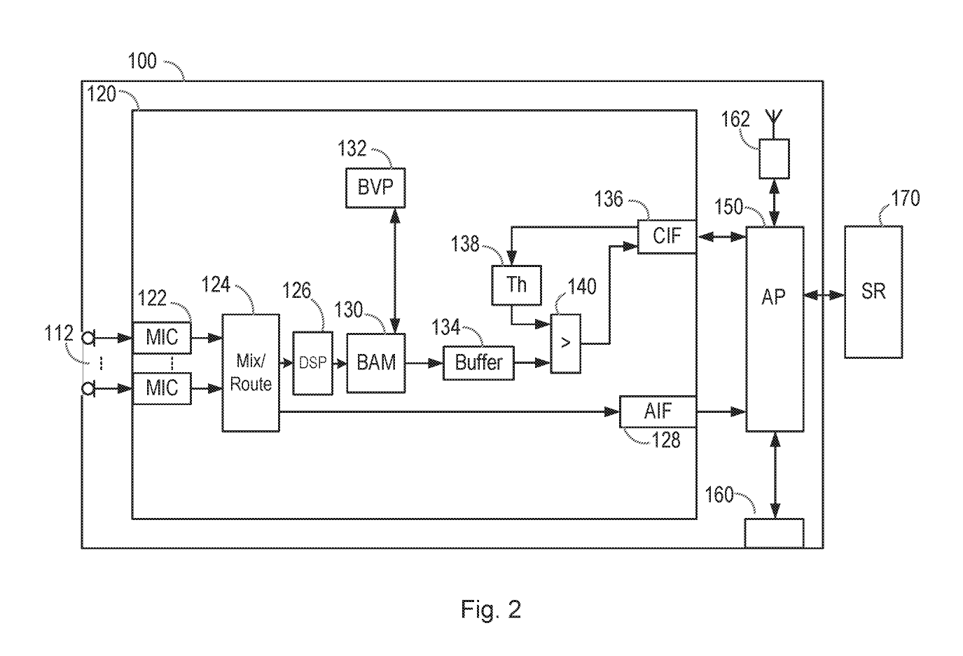

FIG. 2 shows an example of an electronic device 100, which may for example be a mobile telephone or a mobile computing device such as laptop or tablet computer. The device comprises one or more microphones 112 for receiving voice input from the user, a speaker recognition processor (SRP) 120 connected to the microphones 112, and an application processor (AP) 150 connected to the SRP 120. The SRP 120 may be provided on a separate integrated circuit, for example, as illustrated.

The device 100 further comprises one or more components that allow the device to be coupled in a wired or wireless fashion to external networks, such as a wired interface 160 (e.g. a USB interface) or a wireless transmitter module 162 to provide wireless connection to one or more networks (e.g. a cellular network, a local Bluetooth® or a wide area telecommunication network). The device 100 may also comprise one or more storage components providing memory on a larger scale. These components are largely conventional and are therefore not described in any detail.

The microphones 112 are shown positioned at one end of the device 100. However, the microphones may be located at any convenient position on the device, and may capture more sources of sound than simply the user's voice. For example, one microphone may be provided primarily to capture the user's voice, while one or more other microphones may be provided to capture surrounding noise and thus enable the use of active noise cancellation techniques. To enable speakerphone mode in mobile telephones, or in other devices, for example lap-top computers, multiple microphones may be arranged around the device 100 and configured so as to capture the user's voice, as well as surrounding noise.

The SRP 120 comprises one or more inputs 122 for receiving audio data from the microphones 112. Circuitry associated with an input 122 may comprise analog-to-digital convertor circuitry for receiving signals from analog microphones. In some embodiments, one or more of inputs 122 may comprise a digital interface for accepting signals from digital microphones. Such digital interfaces may comprise standard 1-bit pulse-density-modulated (PDM) data streams, or may comprise other digital interface formats. Some or all of microphones 112 may be coupled to inputs 122 directly, or via other circuitry, for example ADCs or a codec, but in all cases such inputs are still defined as microphone inputs in contrast to inputs used for other purposes. In the illustration, a single input 122 is provided for the data from each microphone 112. In other arrangements, however, a single input 122 may be provided for more than one, or even all, of the microphones 112, for example if a time-multiplexed digital bus format such as Soundwire™ is employed.

The SRP 120 further comprises a routing module 124. Routing module 124 may be configurable to accept audio data from selected one or more inputs 122 and route this data to respective routing module outputs. In some embodiments, routing module 124 may be configurable to provide on any requested one or more routing module outputs a mix of input audio data from respective selected any two or more of the inputs 122, and thus may additionally comprise a mixing module or mixer. Routing module 124 may be configurable to apply respective defined gains to input or output audio data. In other embodiments, a digital signal processor may be provided and configured to provide the function of the routing module 124.

In the illustrated embodiment, the routing module 124 comprises two routing module outputs. A first output is coupled to an audio interface (AIF) 128, which provides an audio output interface for SRP 120, and is coupled to the AP 150. A second output is coupled to a biometric authentication signal path comprising a biometric authentication module (BAM) 130.

The configuration of the routing module 124 may be controlled in dependence on the values stored in routing registers (not illustrated). For examples, the routing registers may store values specifying one or more of: at which outputs the routing module 124 is to output audio data, which input or combination of inputs 122 each output audio data is to be based on, and with what respective gain before or after mixing. Each of the routing registers may be explicitly read from and written to by the AP 150 (e.g. by driver software executed in the AP 150), so as to control the routing of audio data according to the requirements of different use cases.

Many use cases of the device 100 may require no biometric authentication of the data present on the inputs 122. For example, audio data of the user's voice may be required for the device 100 to operate normally as a telephone. In that case, the routing module 124 may be configured so as to output audio voice data directly to the audio interface 128 (from where it can be output to the AP 150, for example). Other use cases may also require that the audio data be output directly to the audio interface 128. For example, when the device 100 additionally comprises one or more cameras, it may be used to record video. In that use case, again audio data may be routed directly to the audio interface 128 to be output to the AP 150.

However, one of more of the use cases may require that audio data be provided to the biometric authentication signal path in addition to, or alternatively to, the AIF 128.

The authentication signal path optionally includes a digital signal processor (DSP) 126 configured to enhance the audio data in one or more ways. Those skilled in the art will appreciate that many algorithms may be carried out by the DSP 126 in order to enhance and amplify those portions of the audio data corresponding to the user's voice. The present disclosure is not limited to any particular algorithm or set of algorithms. For example, the DSP 126 may employ one or more noise reduction techniques to mitigate or cancel background noise and so increase the signal-to-noise ratio of the audio data. The DSP may use beamforming techniques to improve the quality of the audio data. In general, these techniques require data from multiple microphones 112 and thus the routing module 124 may output audio data from multiple microphones via the signal path to the DSP 126.

Thus the signal path from microphones 122 may comprise multiple strands from the microphones to the DSP 126. Similarly, the output from the DSP may comprise multiple strands, for example carrying information corresponding to different audio signal frequency bands. Thus the term signal path should be considered to denote the general flow of information from possibly multiple parallel sources to multiple parallel destinations, rather than necessarily a single wired connection for example. In some embodiments a portion of such a signal path may be defined in terms of controlled read and writes from a first defined set of memory locations to which input data has been supplied (e.g. from microphones 112) to a second defined set of locations in memory from which output data may be read by the next component in the signal path (e.g. by DSP 126).

The signal path further comprises a voice biometric authentication module 130. The voice biometric authentication module 130 may be implemented for example as a DSP (either the same DSP 126 that carries out audio enhancement, or a different DSP). The voice authentication module 130 carries out biometric authentication on the pre-processed audio data in order to generate an authentication score.

The biometric module 130 may have access to one or more databases allowing the user's voice to be identified from the audio data. For example, the authentication module 130 may communicate with a storage module 132 containing one or more templates or other data such as a biometric voice print (BVP) allowing identification of the voices of one or more authorised users of the device 100. In the illustrated embodiment the BVP is stored in memory 132 provided on the SRP 120. However, in other embodiments the BVP may be stored on memory outside the SRP 120, or on a server that is remote from the device 100 altogether.

The precise nature of the algorithm carried out in the authentication module 130 is not relevant for a description of the invention, and those skilled in the art will be aware of the principles as well as several algorithms for performing voice biometric authentication. In general, the process may involve a comparison of parameters derived from the acquired (and optionally pre-processed) audio data to corresponding parameters stored in the storage module 132. These parameters may for instance be related to Mel-frequency cepstral coefficients (MFCC) of the audio data. To allow a parallel relative comparison against a set of other users, the authentication module 130 may also access a universal background model (UBM) and/or a cohort model as part of the authentication process, and these may be stored together with the BVP in storage module 132, which may also store firmware used to run the algorithm in the SRP 120.

The output of the biometric authentication module is a score indicating the likelihood that voice data contained within the audio signal corresponds to the voice of an authorised user of the device 100. For example, the score may be indicative of the likelihood that voice data contained within the audio signal corresponds to the voice of an authorised user as opposed to a generic speaker (such as may be derived from the UBM). The score may take any value as required by the designer of the authentication system, and may take a value within a range of values extending from a lower limit (indicating absolute confidence that the speaker is not an authorised person) to an upper limit (indicating absolute confidence that the speaker is an authorised person).

For example, the score may comprise one or more of a log likelihood ratio, an a posterior probability and one or more distance metrics. A log-likelihood ratio may be defined as the logarithm of the ratio between the likelihood that voice data contained within the audio signal corresponds to the voice of an authorised user (e.g. the BVP) as opposed to a generic speaker (such as may be derived from the UBM). An a posterior probability may be defined as the probability that an authorised user uttered the voice data contained within the audio signal (e.g. if the biometric algorithm is based on Bayesian principles). A distance metric may be defined in any way that represents the distance between the voice data contained within the audio signal and the BVP stored in storage module 132. For example, the distance metric may comprise the total distance between spectral features stored in the BVP 120 and corresponding features extracted from the audio signal. The distance metric may comprise any suitable distance (such as cosine distance, Euclidean distance, etc) between a vector representing an authorised speaker (i.e. contained in the BVP) and a corresponding vector representing the audio signal. The vectors may comprise i-vectors or super vectors, for example.

Once calculated, the score is output and stored in a buffer memory 134 provided on the SRP 120.

The SRP 120 further comprises a control interface (CIF) 136 for receiving control signals (e.g. from AP 150) and outputting control signals (e.g. to AP 150). According to embodiments of the disclosure, a control signal received on the CIF 136 comprises an indication of one or more threshold values to be used in determining whether the voice contained within the audio signal is an authorised user or not. This indication may be passed to a threshold interpretation module 138, which generates the threshold value(s) specified within the control signal, and the threshold value(s) are then input to comparison circuitry 140. Comparison circuitry 140 compares the threshold value(s) to the biometric score stored in the buffer 134, and generates a biometric authentication result to indicate whether the voice contained within the audio signal is that of an authorised user or not. For example, if the biometric score exceeds the threshold value, the comparison circuitry 140 may generate a positive result to indicate that the voice contained within the audio signal is that of an authorised user.

The data contained within the control signal contains a desired FAR or FRR value.

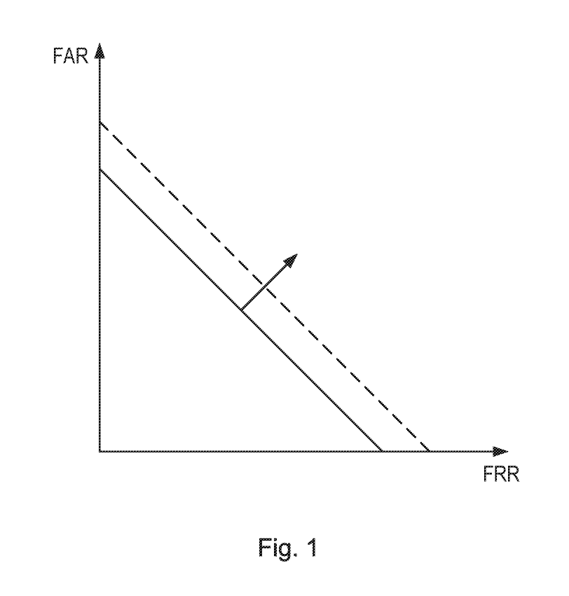

From FIG. 1, it can be seen that the FAR and FRR values both increase as the performance of the authentication algorithm is degraded (e.g., due to increased noise levels). Thus, in order to achieve a desired FAR or FRR value (i.e. one specified in the control signal), in some embodiments the threshold interpretation module 138 may determine an appropriate threshold value based on the desired FAR or FRR value specified in the control signal. The threshold interpretation module 138 may additionally take into account a measure of the noise levels in the audio signal. The amplitude of the audio signal measured over a time window will be relatively large if voice is present and relatively small if voice is absent and the signal is primarily noise. The range of amplitude over a set of time windows may thus be indicative of the noise level relative to the voice components of the audio signal. The measure of the noise levels in the audio signal may comprise or be based on the range of amplitude in the audio signal. That is, a relatively large range in the audio signal may be indicative of low-noise conditions; a relatively small range in the audio signal may be indicative of high-noise conditions.

In some embodiments, the threshold interpretation module 138 may comprise or have access to respective sets of threshold values for multiple different noise levels (e.g. in a look-up table). Each set of threshold values may comprise mappings between desired FAR or FRR values and corresponding threshold values that achieve those desired FAR or FRR values for the given noise level. Such threshold values may be determined in advance, empirically based on a large dataset, or computed theoretically.

In one embodiment, scores may be normalized according to a mathematical model. For example, the normalization may be applied so that all input audio signals produce comparable scores in which the impact of noise on the comparison is lessened, or eliminated entirely. One technique to achieve such normalization is known in the art as test normalization or “TNorm”.

For this purpose, a cohort of speakers, that does not include the authorised user, is considered to score the input audio signal. The cohort of speakers may be selected from a set of example speaker stored on the SRP 120 (e.g. in the storage module 132). The cohort may be selected randomly from the set of example speakers. The cohort may be selected to be of the same gender of the speaker present in the input audio signal (or “test”) once the gender of such speaker has been detected using a gender detection system (which may be implemented in the biometric authentication module 130, for example).

This produces a set of scores that provides an approximation of the distribution of same-gender impostor scores (i.e. having the same gender as the input audio signal but not being the authorised user) for that particular input audio signal. This set of scores is used to “normalize” the score of the user, following this simple formulation:

$$μ = \frac{{\sum }_{i = 1 …C} {s}_{i}}{C}$$

$$σ = \sqrt{\frac{{\sum }_{i = 1 …C} {( {s}_{i} - μ )}^{2}}{C - 1}}$$

$${s}_{NORM} = \frac{{s}_{USER} - μ}{σ}$$

where sᵢ are the scores obtained comparing the input audio with the i element of the cohort (i=1 . . . C), C is the number of elements in the cohort, μ and σ are the mean and typical deviation of the scores for the cohort, s_{USER} is the score obtained comparing the input audio with the authorised user model, and s_{NORM} is the normalized score.

It is assumed (and it is known as a good approximation for the skilled in the area) that the same-gender impostor score distribution follows a Gaussian distribution, so after estimating its mean and typical deviation using the cohort, the normalization process generates a score that, in case of being an impostor, will follow a standard normal distribution:

s_{NORM}˜N(0,1)

Such a normal distribution may be used to set the threshold value to obtain a given FAR.

This can be done mathematically by finding the threshold value ε(FAR) that meets:

$$FAR = \frac{1}{2} {\int }_{e ( FAR )}^{∞} P ( x \vert 0 , 1 ) dx$$

$$x \text{∼} N ( 0 , 1 ) \to P ( x \vert 0 , 1 ) = \frac{1}{\sqrt{2 π}} {e}^{\frac{{x}^{2}}{2}}$$

where it has been assumed that audio signals uttered by a person of a gender different to the user will have always a score too low to be considered (so the actual FAR is half of the proposed integral). Alternatively, different-gender impostors may be considered equally, as if they were as competitive as same-gender impostors, and the same formulation can be applied without the ½ term.

The threshold value may also be obtained experimentally by running an experiment (i.e. obtaining a large dataset of impostor scores, during a development phase) and finding the threshold value that obtains the desired FAR. The dataset may be obtained under a wide variety of conditions, e.g. noise, transmission conditions, recording conditions, etc. Let S_{NORM}=(s_{NORM}_{₁}, s_{NORM}_{₂}, . . . , s_{NORM}_{_{N}}) be the set of N normalized impostor scores

$$( e . g . , where N is larger than 30 \times \frac{1}{FAR} ) .$$

The steps to follow are below:
1. Sort S_{NORM}, e.g., into descending order
2. Determine the score s_{NORM}_{_{FAR}} in the sorted S_{NORM} that fulfils, for the desired FAR:

rank=(s_{NORM}_{_{FAR}})=N×FAR
3. Set the threshold as the score

ϵ(FAR)=s_{NORM}_{_{FAR}}

Other methods of determining an appropriate threshold value based on a requested FAR or FRR value may be used, as known in the art. Further, more than one method may be employed, e.g. to validate the threshold value and give some confidence that it is appropriate. For example, both the experimental and theoretical methods set out above may be employed to determine the threshold value. If each method suggests a different threshold value (i.e. threshold values that differ from each other by more than a threshold amount), then an error message may be generated and the process aborted.

The threshold values indicated in the control signal may be limited to a finite set of discrete values. For example, when the control signal explicitly contains the threshold value itself, the threshold value may be selected by the AP 150 from one of a finite number of threshold values. When the control signal contains an indication of a desired FAR or FRR value, those FAR or FAR values may be selected by the AP 150 from one of a finite number of FAR or FRR values. An advantage of this implementation is that the AP 150 is unable to run the authentication multiple times with incrementally different threshold values. For example, malicious software installed on the AP 150 may attack the authentication system by running the authentication repeatedly with incrementally different threshold values, and so determine a fine-grained biometric score for a particular audio input. This might allow the software to modify the audio input monotonically and determine whether the biometric score changes, eventually increasing the score until the authentication module 130 can be spoofed with a maliciously synthesized audio input. By ensuring that the AP 150 is able to select only from a limited set of threshold values, this risk is mitigated.

In further embodiments, the control signal may contain one or more of a plurality of predefined labels, which are mappable to particular threshold values or particular FAR or FRR values. In the latter case, the FAR and FRR values may in turn be mapped to threshold values. For example, the authentication system may be operable at a plurality of different settings, such as “low”, “medium” and “high”, with corresponding indications in the control signal. In the threshold interpretation module 138, these settings are mapped to particular FRR or FAR values, and to corresponding threshold values. For example, a “low” setting might indicate a relatively high FAR value, or a relatively low FRR value, and therefore a relatively low threshold value; a “high” setting a relatively low FAR value, or a relatively high FRR value, and therefore a relatively high threshold value; and a “medium” setting a threshold in between those two values. However, in practice any number of settings may be provided. An advantage of this implementation is that the AP 150 may be kept ignorant of the particular threshold values used in each case, so obscuring detail of the algorithm's performance target at different security settings.

Once generated, the biometric authentication result is output from the SRP 120 via CIF 136 and provided to AP 150, for example, to authorise a restricted operation of the device 100, such as unlocking the device, carrying out a financial transaction, etc. The biometric authentication result may be appended with the indication of the threshold values used by the comparison circuitry to generate the result. Thus, where the control signal received on the control interface 136 specifies a particular FAR/FRR value or a label, the biometric authentication result may be appended with that same FAR/FRR value or label. This enables the AP 150 to detect any attempt by a man-in-the-middle attack to alter the FAR/FRR operating point either used for the calculation, or indicated alongside the result.

The biometric authentication result may be authenticated (i.e. with a digital signature) to further protect against man-in-the-middle attacks attempting to spoof the result, including protection against replay attacks. For example, this may be performed by the AP 150 sending to the SRP 120 a biometric verification result request (which may be the control signal containing the indication of the FAR/FRR values to be used or a different control signal) containing a random number. The SRP 120 may then append the authentication result to this message, sign the whole message with a private key, and send it back to the AP. The AP 150 can then validate the signature with a public key, ensure that the returned random number matches that transmitted, and only then use the biometric authentication result.

FIG. 2 thus discloses an electronic device 100 in which biometric authentication may be carried out in a speaker recognition processor 120 and the operating FAR/FRR point controlled dynamically by the AP 150.

One or more embodiments may require the use of speech recognition to determine the semantic content of the voice data signal. FIG. 2 thus additionally contains a speech recognition module 170 configured to determine the semantic content of the voice contained within the audio signal. Note that the speech recognition module 170 may be implemented in a server that is remote from the electronic device 100 (e.g. in the “cloud”), or in the AP 150 itself, or in another circuit provided in the device 100 (such as a dedicated speech recognition circuit). In embodiments where the speech recognition module 170 is implemented remotely from the electronic device, the audio signal (or relevant parts thereof) may be communicated to the module 170 via the wired or wireless interfaces 160, 162, for example, and speech recognition results returned by the same mechanisms.

As noted above, one or more operations of the device 100 may require biometric authentication of the user before they can be carried out. For example, biometric authentication of the user may be required for one or more of: carrying out a financial transaction using the device 100 (e.g. via a banking or wallet app installed on the device); accessing encrypted communications such as encrypted e-mails; changing security settings of the device; allowing access to the device via a lock screen; turning the device on, or otherwise changing a power mode of the device (such as waking from sleep mode). The set of operations requiring biometric authentication may be configurable by the user, so as to apply a level of security that the user is comfortable with.

It is becoming increasingly common for users of electronic devices to control their devices using their voice. For example, a user may speak to his or her electronic device in order to wake it from a locked, sleep state. The user may be required to speak a particular password or passphrase. One well-known example of this is use of the phrase, “OK Google” to wake devices running software developed by Google Inc. or devices running software developed by Google Inc. However, it is expected that users will increasingly use their voice to control their devices to carry out various operations. Such operations may require user authentication, and thus it is desirable to enable a use case in which a user may utter a command or passphrase/password to his or her device, and have the device carry out the requested operation even if the operation requires user authentication (i.e. without further input). In these embodiments, biometric authentication and speech recognition are thus carried out on the same audio input.

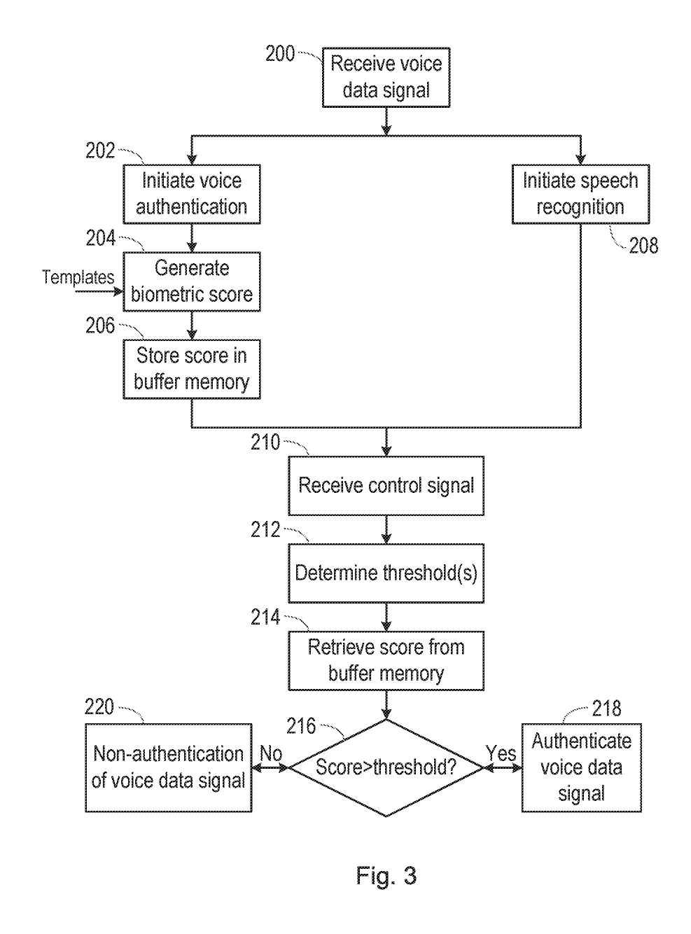

FIG. 3 shows a flowchart of a method according to embodiments of the disclosure. The method may be carried out primarily in the SRP 120 shown above in FIG. 2. Initially, the routing module 124 may be configured by the AP 150 to route audio signals from the inputs 122 to both the authentication signal path and the AIF 128.

In step 200, a user of the device 100 speaks into the microphone(s) 112 and a voice signal is captured and provided at the inputs 122. In accordance with the configuration of the routing module 124, the audio signal is provided to both the DSP 126 and the AIF 128. In alternative embodiments, the audio signal may be routed only to the DSP 126, but the DSP 126 may be configured to provide the audio signal to the AP 150 as well as the biometric authentication module 130.

The SRP 120 or AP 150 may comprise a voice trigger detection module, operable to trigger authentication and/or speech recognition upon initial detection of a specific word or phrase contained within the audio signal (such as a password or passphrase) that demarcates the start of a voice command. For example, if provided in the SRP 120, the voice trigger detection module may be implemented in the DSP 126, or alternatively at least partially on dedicated circuitry in the SRP 120, which may be designed for low power consumption and hence configured to be active even when other components of the SRP 120 are powered down.

In step 202, upon detection of the trigger phrase, biometric authentication of the voice data signal is initiated. Thus, if present, the DSP 126 may carry out one or more algorithms operable to enhance the audio data in one or more ways. Those skilled in the art will appreciate that many algorithms may be carried out by the DSP 126 in order to enhance and amplify those portions of the audio data corresponding to the user's voice. For example, the DSP 126 may employ one or more noise reduction techniques to mitigate or cancel background noise and so increase the signal-to-noise ratio of the audio data. Alternatively or additionally, the DSP 126 may use beamforming techniques to improve the quality of the audio data.

The biometric authentication module 130 then receives the (optionally enhanced) voice data signal and initiates biometric authentication of the signal to determine the likelihood that the voice contained within the signal is that of an authorised user.

As noted above, the precise nature of the algorithm carried out in the authentication module 130 is not relevant for a description of the invention, and those skilled in the art will be aware of the principles as well as several algorithms for performing voice biometric authentication. In general, the process may involve a comparison of parameters derived from the acquired (and optionally pre-processed) audio data to corresponding parameters or templates, for example a biometric voice print (BVP) stored in the storage module 132. These parameters may for instance be related to Mel-frequency cepstral coefficients (MFCC) of the audio data. To allow a parallel relative comparison against a set of other users, the authentication module 130 may also access a universal background model (UBM) and/or a cohort model as part of the authentication process, which may also be stored in storage module 132.

In step 204, the biometric authentication module outputs a score indicating the likelihood that voice data contained within the audio signal corresponds to the voice of an authorised user of the device 100. For example, the score may be indicative of the likelihood that voice data contained within the audio signal corresponds to the voice of an authorised user as opposed to a generic speaker (such as may be derived from the UBM). The score may take any value as required by the designer of the authentication system, and may take a value within a range of values extending from a lower limit (indicating absolute confidence that the speaker is not an authorised person) to an upper limit (indicating absolute confidence that the speaker is an authorised person). For example, the score may comprise one or more of a log likelihood ratio, an a posterior probability and one or more distance metrics. Once calculated, the score is output and stored in the buffer memory 134, in step 206.

The biometric authentication module 130 may also initiate an algorithm to determine whether or not the voice data signal is a spoof signal. For example, it is known to attack biometric authentication algorithms by recording the user's voice, or synthesizing an audio signal to correspond to the user's voice, and playing that recorded or synthesized signal back to the authentication module in an attempt to “spoof” the biometric authentication algorithm. The biometric authentication module 130 may thus perform an algorithm to determine whether the voice data signal is a spoof signal, and generate a corresponding score indicating the likelihood that the voice data signal is a genuine signal (i.e. not a spoof signal). The algorithm may determine the presence of spectral artefacts indicative of a spoofing attempt (i.e. features related to replay of recordings through loudspeakers or reverberation due to unexpectedly far-field recorded audio). For example, the biometric authentication module 130 may perform one or more algorithms as described in European patent application EP 2860706.

As noted above, a voice trigger detection module may trigger biometric authentication and/or speech recognition upon detection that an audio signal contains voice content. In step 208, therefore, speech recognition is initiated on the voice data signal received in step 200. Such initiation may involve the SRP 120 sending the audio data to the AP 150 (e.g. over the AIF 128), and the AP 150 sending the audio data to the speech recognition module 170.

In step 210, a control signal is received by the SRP 120 containing an indication of one or more FAR/FRR values to be used in determining whether the voice contained within the audio signal is that of an authorised user or not. As noted above, the indication may be a particular FAR or FRR value or a predetermined label for example.

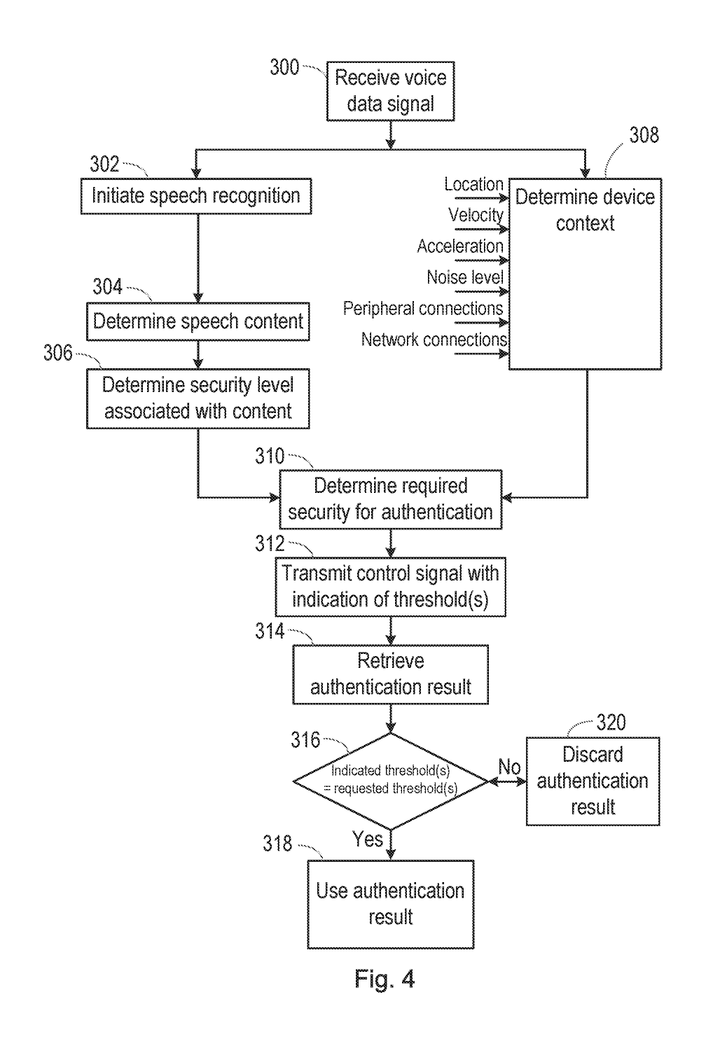

According to embodiments of the disclosure, the FAR/FRR values may be determined based on the semantic content of the voice signal. This aspect of the disclosure will be described in greater detail below in relation to FIG. 4. However, the voice input may contain one or more of a command, password and passphrase associated with a corresponding restricted operation of the device 100, for example. The restricted operation may be associated with a predetermined level of security (e.g. configurable by one or more of the user, the manufacturer of the device 100, the developer of software running on the device 100, a third party operating a service to which the device 100 has connected, etc). Different operations may be associated with different levels of security. For example, a financial transaction may require a relatively high (or the highest) level of security, whereas unlocking the device 100 may be associated with a relatively lower level of security. The FAR/FRR values may thus be set accordingly by the AP 150, so as to achieve the desired level of security in accordance with the content of the voice data signal.

According to further embodiments of the disclosure, the FAR/FRR values may be based on a context in which the voice data signal was acquired. For example, the AP 150 may be able to determine one or more of: a location of the electronic device 100; a velocity of the electronic device 100; an acceleration of the electronic device 100; a level of noise in the voice data signal; one or more peripheral devices to which the electronic device 100 is connected; and one or more networks to which the electronic device 100 is connected. Such data may enable the AP 150 to determine whether the device 100 is at a geographical location corresponding to the home or other known location of an authorised user, for example. If the determined context matches an expected context for an authorised user, the security requirements may be relaxed (i.e. the FRR value may be set relatively low, while the FAR value may be set relatively high); if the determined context does not match an expected context for an authorised user, the security requirements may be maintained or increased (i.e. the FRR value may be set relatively high, while the FAR value may be set relatively low).

Note that these embodiments may be combined such that FAR/FRR values are determined based on both the semantic content of the voice data signal and the context in which the voice data signal was acquired.

In the illustrated embodiment, speech recognition is carried out in parallel with biometric authentication. That is, initiation of biometric authentication and initiation of speech recognition may happen substantially simultaneously, or close enough that at least part of the biometric authentication carried out in the biometric authentication module 130 takes place at the same time as at least part of the speech recognition in the speech recognition module 170. The advantage of this parallel processing is that the amount of time required to process the audio data and generate an authentication result is reduced, particularly as both biometric authentication and speech recognition are computationally complex tasks. However, in other embodiments, the biometric authentication and speech recognition may occur sequentially.

In the illustrated embodiment, therefore, the control signal is received in step 210 after the speech biometric authentication has been initiated in step 202. Indeed, in some embodiments (and the illustrated embodiment), the control signal is received in step 210 after the speech biometric score generation has completed in step 204. This is to be expected as, according to algorithms currently available, the process of speech recognition generally takes longer than the process of biometric score generation. However, that may change in future or, as noted above, speech recognition may be carried out before biometric score generation. Thus in some embodiments the control signal may be received before biometric authentication is initiated.

In step 212, the threshold interpretation module 138 determines the threshold values indicated by the control signal, based on the FAR/FRR values. In step 214 the biometric score stored in the buffer 134 is retrieved, and in step 216 the comparison circuitry compares the biometric score to the one or more threshold values. If the biometric score is above the threshold(s), the voice data signal is authenticated and a positive authentication result is generated and passed to the AP 150 via the control interface 136. As noted above, the authentication result may be appended with an indication of the threshold values used by the comparison circuitry to generate the result (particularly in embodiments where the control signal does not contain the threshold values themselves but a predetermined label, for example). The biometric authentication result may also be authenticated (i.e. with a digital signature).

If the biometric score is less than the threshold values (or at least one of the threshold values in embodiments comprising more than one threshold), the voice data signal is not authenticated. A negative authentication result may be generated by the comparison circuitry 138 and passed to the AP 150 via the control interface 136. Again, the result may be appended with an indication of the applied threshold values, and authenticated.

Note that, in some embodiments, more than one threshold value may be indicated in the control signal, with respective threshold values indicated for comparison with the biometric score (for determining whether the voice in the voice data signal belongs to an authorised user), and for comparison with the anti-spoofing score (for determining whether the voice data signal is genuine or recorded/synthesized). The comparison circuitry may combine the individual comparison results in order to generate the overall authentication result. For example, a negative authentication result may be generated by the comparison circuitry 138 if any one of the scores is below its respective threshold. In other embodiments, the comparison of the biometric score with its threshold may be relied on solely (for example, if the anti-spoofing algorithm is not carried out, or if anti-spoofing is considered low risk).

It will be noted that more than one threshold value may also be specified and utilized in the following manner. For example, the control signal may specify an upper FAR/FRR value and a lower FAR/FRR value (corresponding to upper and lower threshold values). If the biometric score exceeds the upper threshold value, the voice within the voice data signal may be authenticated as that of an authorised user. If the biometric score is less than the lower threshold, a negative authentication result may be provided, i.e. the SRP 120 is confident that the voice within the audio signal is not that of an authorised user. If the biometric score is between the upper and lower thresholds, however, this is an indication that the SRP 120 is unsure as to whether or not the voice is that of an authorised user. In that case, the authentication process may be repeated, for example by requesting that the user repeats the password or passphrase previously uttered (perhaps in a less noisy environment) and the authentication process carried out on different audio input signals, or by altering the audio enhancing algorithms performed in the DSP 126 so as to alter the signals input to the biometric authentication module 130 and so alter the biometric score.

FIG. 4 shows a flowchart of a method according to further embodiments of the disclosure. The method may be carried out primarily in the AP 150 shown above in FIG. 2.

In step 300, a user of the device 100 speaks into the microphone(s) 112 and a voice signal is captured and provided at the inputs 122. In accordance with the configuration of the routing module 124, the audio signal is provided to and received by the AP 150 (potentially as well as the DSP 126 and biometric authentication module 130). In alternative embodiments, the audio signal may be provided to the AP 150 via the DSP 126.

In step 302, the AP 150 initiates speech recognition on the voice data signal received in step 300. Such initiation may involve the AP 150 sending the audio data to the speech recognition module 170. As noted above, the speech recognition module 170 may be implemented in the AP 150 itself, in a separate, dedicated integrated circuit within the device 100, or in a server that is remote from the device 100 (e.g. in the cloud).

In step 304, the speech recognition module 170 determines the speech content (also known as the semantic content) and returns that content to the AP 150. For example, the speech recognition module 170 may employ neural networks and large training sets of data to determine the speech content. Alternatively, particularly if implemented within the device 100, the speech recognition module 170 may be configured to recognize a more limited vocabulary of words without requiring a connection to a remote server. The AP 150 then determines the relevance of the speech content to the device 100 and software running on the device 100. For example, the speech content may contain one or more commands instructing the device 100 to carry out a particular operation. For example, the operation may require biometric authentication in order to be authorised. The command may be an instruction to carry out a particular operation (e.g. to gain access to restricted software or memory locations, or to carry out a function that requires authentication, such as a financial transaction). Alternatively, or additionally, the command may correspond to a password or passphrase registered with the device 100, used to gain access to the device (e.g. to wake the device from a sleep state or locked state).

Assuming that the speech content contains a command or other utterance that requests a restricted operation (and thus requires appropriate authentication), the AP 150 determines in step 306 the security level associated with the restricted operation. A plurality of different security levels may be defined, with different restricted operations requiring different security levels (as configured by the user, the device manufacturer, the software developer, or a third party to which the device is connected such as the receiving party in a financial transaction). For example, certain operations may require relatively high levels of security, such as financial transactions, or financial transactions above a threshold amount of money; conversely, other operations may require relatively lower levels of security, such as waking the device 100 from a sleep or locked state. Some requested operations may be associated with low or no security requirements, but it may nonetheless be convenient for the operations to be carried out only by the device 100 of the requesting user (and not any other device in the vicinity). For example, a user may utter a command with no security requirements (such as checking the next calendar event, or the weather forecast). It may nonetheless be convenient for only the user's device 100 to respond and carry out the requested operation (i.e. upon authentication of the user's voice), rather than any other device that may have detected the user's voice.

In step 308, the AP 150 additionally determines the context in which the voice data signal was acquired. In the illustrated embodiment, this step happens in parallel with the speech recognition. However, in other embodiments, for example if the speech recognition module 170 is implemented within the AP 150 itself, this step may be carried out after the speech recognition in steps 302 and 304.

For example, the AP 150 may be able to determine one or more of: a location of the electronic device 100 when the voice data signal was acquired (e.g. through GPS or other geographical positioning services); a velocity of the electronic device 100 when the voice data signal was acquired (again, through GPS or other similar services); an acceleration of the electronic device 100 when the voice data signal was acquired (e.g. through communication with one or more accelerometers in the device 100); a level of noise in the voice data signal (e.g. through analysis of the frequency content of the signal and the voice-to-noise ratio); one or more peripheral devices to which the electronic device 100 was connected when the voice data signal was acquired (e.g. by analysis of the connections on wired interface 162 or other interfaces of the device 100); and one or more networks to which the electronic device 100 was connected when the voice data signal was acquired (e.g. through analysis of connections over the wired and wireless interfaces 160, 162).

Such data may enable the AP 150 to determine the context of the device 100 when the voice data signal was acquired. For example, the AP 150 may be able to determine, with a high degree of certainty, that the device 100 was at a home location of an authorised user when the voice data signal was acquired. A number of different pieces of information may support this determination, such as the geographical location of the device, connections to one or more home networks, low or zero movement, etc. Similar principles may apply to the regular place of work of an authorised user. The AP 150 may be able to determine whether the device 100 was in a motor vehicle when the voice data signal was acquired. For example, the velocity of the device, the noise profile in the voice data signal, and a connection to a vehicular computer may all support such a determination.

Such known contexts may be pre-registered by the authorised user with the electronic device 100 or learned by the device through machine learning, for example.

In step 310, the AP 150 determines the appropriate security level for the authentication process required by the command contained within the voice data signal.

According to embodiments of the disclosure, the security level determined in step 306 may dictate a certain level of security. Certain restricted operations may mandate a particular level of security (such as the highest level of security) regardless of the context. However, in other embodiments, the context in which the voice data signal was acquired may additionally be used to determine the appropriate level of security. For example, if the device 100 was in a context that is a known context for an authorised user, the security level may be lowered for certain restricted operations so as to increase the reliability of the authentication process (i.e. to reduce the FRR).

It should be noted that in further embodiments still, all restricted operations may be associated with the same security level, such that the context in which the voice data signal was acquired alters the required security level but the restricted operation itself does not.

In step 312, the AP 150 transmits to the SRP 120 a control signal containing an indication of one or more FAR/FRR values to be used in determining whether or not the voice contained within the voice data signal is that of an authorised user. As noted above, the SRP 120, and particularly the biometric authentication module 130, performs a biometric algorithm on the voice data signal and produces a biometric score indicating the likelihood that the voice in the data signal is that of an authorised user. The authentication algorithm may take place at the same time as the speech recognition in steps 302 and 304 or afterwards. As noted above, the indication may be a particular FAR or FRR value, or a predetermined label for example.

In step 314, the SRP 120 generates an authentication result and this is received by the AP 150. The authentication result may be authenticated by signature with a private key of the SRP 120, requiring decryption with a corresponding public key of the SRP 120 contained in the AP 150.

The authentication result may also contain an indication of the FAR/FRR value that was used to generate the authentication result. This should be the same as the indication contained within the control signal transmitted in step 312. However, if different, this may be an indication that a “man in the middle” attack has attempted to subvert the authentication process by using a lower threshold value, making it easier for unauthorised users to gain access to the restricted operation. In step 316, therefore, the AP 150 checks to see whether the indication contained within the authentication result matches the indication contained within the control signal. If the two match, then the authentication result can be used in step 318 to authorise the requested restricted operation. If the two do not match, then the authentication result may be discarded and the requested restricted operation refused.

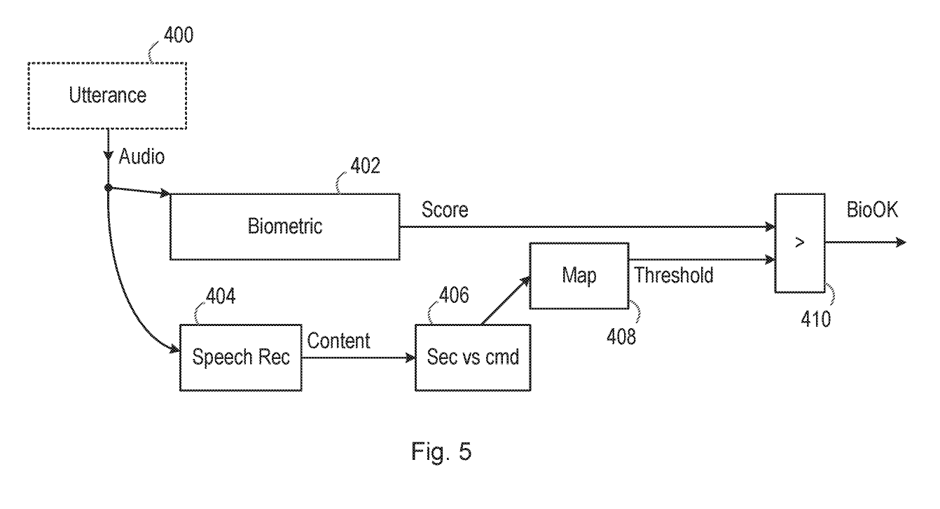

FIG. 5 illustrates the processing of voice input according to embodiments of the disclosure.

The processing starts in action 400 in which an utterance is spoken by a user of an electronic device and captured by one or more microphones. The corresponding audio signal is provided to a biometric authentication module 402, which performs a biometric algorithm on the signal and generates a biometric score indicating the likelihood that the voice contained within the audio signal corresponds to that of an authorised user of the electronic device.

The precise nature of the algorithm carried out in the authentication module 402 is not relevant for a description of the invention, and those skilled in the art will be aware of the principles as well as several algorithms for performing voice biometric authentication. In general, the process may involve a comparison of parameters derived from the acquired (and optionally pre-processed) audio data to corresponding parameters or templates stored in memory corresponding to an authorised user (such as may be produced during an enrolment process, for example). These parameters may for instance be related to Mel-frequency cepstral coefficients (MFCC) of the audio data. To allow a parallel relative comparison against a set of other users, the authentication module 402 may also access a universal background model (UBM) and/or a cohort model as part of the authentication process.

The biometric score may be indicative of the likelihood that voice data contained within the audio signal corresponds to the voice of an authorised user as opposed to a generic speaker (such as may be derived from the UBM). The score may take any value as required by the designer of the authentication system, and may take a value within a range of values extending from a lower limit (indicating absolute confidence that the speaker is not an authorised person) to an upper limit (indicating absolute confidence that the speaker is an authorised person). For example, the score may comprise one or more of a log likelihood ratio, an a posterior probability and one or more distance metrics.

The audio signal is also passed to a speech recognition module 404, that determines and outputs the content (also termed the semantic content) of the utterance within the audio signal. The speech recognition module 404 may be provided in the electronic device or in a remote server.

The determined content is passed to a security module 406 that determines the relevance of the semantic content. If the semantic content contains a command that is recognised within the device to relate to a restricted operation (such as an instruction to carry out a particular task, or a password or passphrase) the security module 406 determines the security level associated with the restricted operation and outputs a control signal containing an indication of the security level. The security module 406 may additionally take into account the context of the device when the utterance was captured.

The control signal is received by a mapping module 408 that maps the required security level to a threshold value for use in determining whether the user should be authenticated as an authorised user of the device. The threshold value is then passed to a comparator module 410, together with the biometric score, which compares the two values and generates an authentication result. If the biometric score exceeds the threshold value, the user may be authenticated as an authorised user of the device, i.e. the authentication result is positive; if the biometric score does not exceed the threshold value, the user may not be authenticated, i.e. the authentication result is negative.

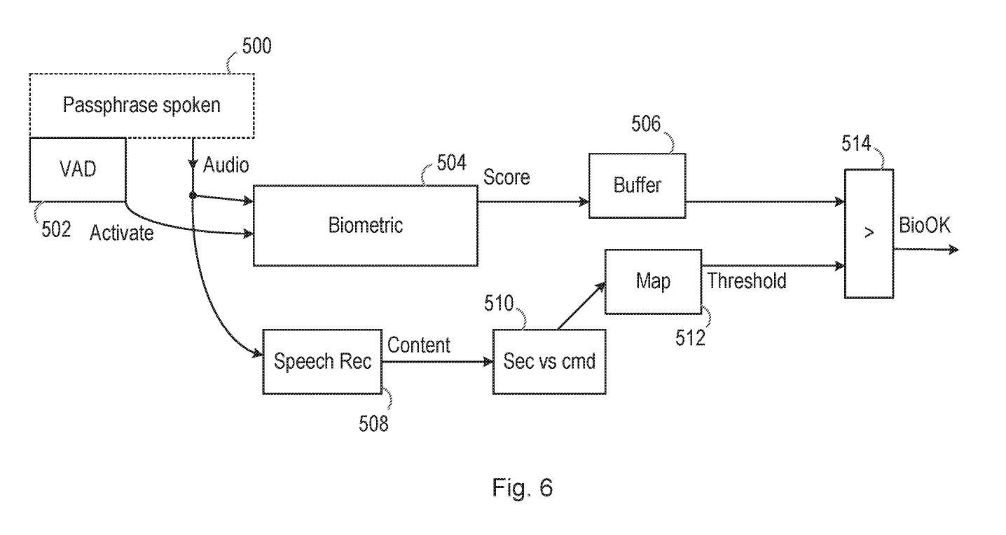

FIG. 6 illustrates the processing of voice input according to further embodiments of the disclosure. This modular processing may be appropriate in modes where the electronic device actively listens for the presence of a command or passphrase/password in an ongoing audio signal generated by one or more microphones.

The processing begins in action 500, where a passphrase or password is spoken by a user of an electronic device and a corresponding audio signal is captured by one or more microphones. The audio signal is captured and stored in a buffer memory, which may be a circular buffer, for example, in which data is written and then written over as the buffer becomes full.

A voice trigger detection module 502 analyses the contents of the buffer memory and, once the passphrase or password is detected, issues an activation signal to a biometric authentication module 504 and a speech recognition module 508.

The audio signal is provided from the buffer to the biometric authentication module 504, which performs a biometric algorithm on the signal and generates a biometric score indicating the likelihood that the voice contained within the audio signal corresponds to that of an authorised user of the electronic device. The biometric score is then stored in a buffer memory 506.

The precise nature of the algorithm carried out in the authentication module 504 is not relevant for a description of the invention, and those skilled in the art will be aware of the principles as well as several algorithms for performing voice biometric authentication. In general, the process may involve a comparison of parameters derived from the acquired (and optionally pre-processed) audio data to corresponding parameters or templates stored in memory corresponding to an authorised user (such as may be produced during an enrolment process, for example). These parameters may for instance be related to Mel-frequency cepstral coefficients (MFCC) of the audio data. To allow a parallel relative comparison against a set of other users, the authentication module 504 may also access a universal background model (UBM) and/or a cohort model as part of the authentication process.

The biometric score may be indicative of the likelihood that voice data contained within the audio signal corresponds to the voice of an authorised user as opposed to a generic speaker (such as may be derived from the UBM). The score may take any value as required by the designer of the authentication system, and may take a value within a range of values extending from a lower limit (indicating absolute confidence that the speaker is not an authorised person) to an upper limit (indicating absolute confidence that the speaker is an authorised person). For example, the score may comprise one or more of a log likelihood ratio, an a posterior probability and one or more distance metrics.

The audio signal is also passed to a speech recognition module 508, that determines and outputs the content (also termed the semantic content) of the utterance within the audio signal. The speech recognition module 508 may be provided in the electronic device or in a remote server.

The determined content is passed to a security module 510 that determines the relevance of the semantic content. If the semantic content contains a command that is recognised within the device to relate to a restricted operation (such as an instruction to carry out a particular task, or a password or passphrase), or where identifying the user ensures that the correct device (i.e. the device of the user) carries out the requested operation, the security module 406 determines the security level associated with the restricted operation and outputs a control signal containing an indication of the security level. The security module 510 may additionally take into account the context of the device when the utterance was captured.

The control signal is received by a mapping module 512 that maps the required security level to a threshold value for use in determining whether the user should be authenticated as an authorised user of the device. The threshold value is then passed to a comparator module 514, together with the biometric score, which compares the two values and generates an authentication result. If the biometric score exceeds the threshold value, the user may be authenticated as an authorised user of the device, i.e. the authentication result is positive; if the biometric score does not exceed the threshold value, the user may not be authenticated, i.e. the authentication result is negative.

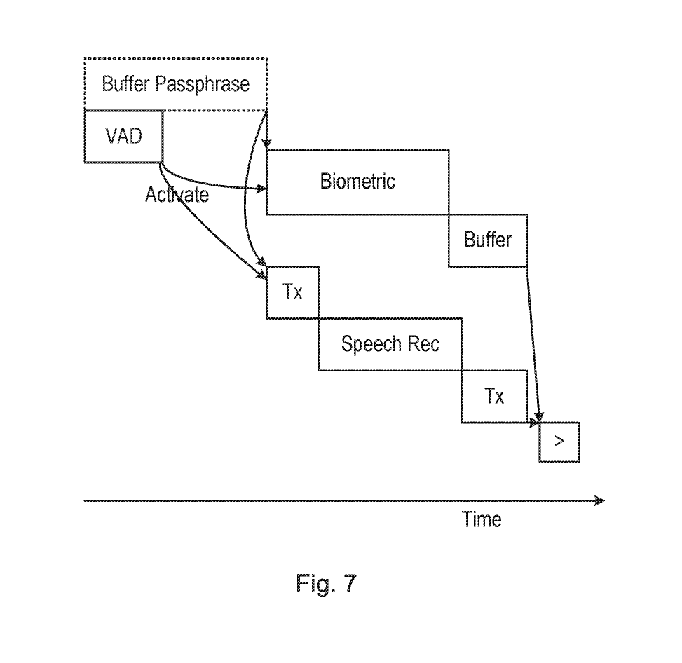

FIG. 7 is a timing diagram showing the processing of voice input according to embodiments of the disclosure. Again, the illustrated processing may be appropriate in modes where the electronic device actively listens for the presence of a command or passphrase/password in an ongoing audio signal generated by one or more microphones.

The processing begins with the audio signal being captured and stored in a buffer memory, which may be a circular buffer, for example, in which data is written and then written over as the buffer becomes full.

In parallel with the buffering of the audio signal, a voice trigger detection module analyses the contents of the buffer memory and, once a trigger phrase or word is detected within the audio data, issues activation signals to initiate biometric authentication and speech recognition of the audio signal contained within the buffer. The biometric authentication and speech recognition may thus be initiated at substantially the same time.

The biometric authentication algorithm can be carried out immediately, for example using any of the authentication modules described above. The speech recognition may require the audio data to be transmitted to a remote speech recognition service module, and thus the transmission of the data requires a finite period of time. The speech recognition algorithm may then begin, with the speech recognition and biometric authentication taking place at the same time.

It is expected that the authentication algorithm may be processed more quickly than the speech recognition, particularly if the speech recognition is performed remotely from the device 100, and thus the biometric authentication completes and stores a biometric score in a buffer memory. The speech recognition algorithm then completes and transmits the determined semantic content of the audio signal back to the electronic device. In accordance with the principles described above, a FAR/FRR value and corresponding threshold value may be determined on the basis of the determined semantic content (and optionally the context of the device), and the biometric score compared to the threshold in a final stage to generate an authentication result.

Embodiments of the disclosure thus provide methods and apparatus in which a biometric authentication score generated as the result of a biometric authentication algorithm is compared to a threshold value that can be dynamically varied as required to provide a variable level of security. For example, the threshold value may be varied in dependence on the semantic content of a voice signal, and/or the context in which the voice signal was acquired. Authentication of the signal may be initiated in parallel with speech recognition, such that the appropriate threshold value is only determined after authentication has already begun (and perhaps may have already completed). In this way, the amount of time required to process a biometric voice input is reduced.

The skilled person will recognise that some aspects of the above-described apparatus and methods, for example the discovery and configuration methods may be embodied as processor control code, for example on a non-volatile carrier medium such as reprogrammable memory (e.g. Flash), a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

Note that as used herein the term module shall be used to refer to a functional unit or block which may be implemented at least partly by dedicated hardware components such as custom defined circuitry and/or at least partly be implemented by one or more software processors or appropriate code running on a suitable general purpose processor or the like. A module may itself comprise other modules or functional units. A module may be provided by multiple components or sub-modules which need not be co-located and could be provided on different integrated circuits and/or running on different processors.

Embodiments may comprise or be comprised in an electronic device, especially a portable and/or battery powered electronic device such as a mobile telephone, an audio player, a video player, a PDA, a wearable device, a mobile computing platform such as a smartphone, a laptop computer or tablet and/or a games device, remote control device or a toy, for example, or alternatively a domestic appliance or controller thereof including a home audio system or device, a domestic temperature or lighting control system or security system, or a robot.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope. Terms such as amplify or gain include possibly applying a scaling factor of less than unity to a signal.

1. A method of carrying out biometric authentication of a speaker, the method comprising:
receiving a voice data signal comprising data corresponding to a voice of the speaker;
performing a biometric authentication algorithm on the voice data signal, the biometric authentication algorithm comprising a comparison of one or more features in the voice data signal with one or more stored templates corresponding to a voice of an authorised user, and being configured to generate a biometric authentication score;
receiving a control signal comprising an indication of one or more of a false acceptance rate and a false rejection rate;
determining one or more thresholds based on the one or more of the false acceptance rate and the false rejection rate; and
comparing the biometric authentication score with the one or more threshold values to determine whether the speaker corresponds to the authorised user.

2. The method according to claim 1, wherein the indication of one or more of the false acceptance rate and the false rejection rate are based on content within the voice data signal.

3. The method according to claim 1, further comprising:
initiating a speech recognition algorithm on the voice data signal to determine a semantic content of the voice data signal.

4. The method according to claim 3, wherein the speech recognition algorithm and the biometric authentication algorithm are performed concurrently.

5. The method according to claim 1, further comprising:
storing the biometric authentication score in a buffer memory; and
prior to the step of comparing the biometric authentication score with the one or more threshold values, reading the biometric authentication score from the buffer memory.

6. The method according to claim 1, further comprising:
determining the one or more threshold values based on the one or more of the false acceptance rate and the false rejection rate and a measure of noise levels in the voice data signal.

7. The method according to claim 1, wherein the indication of the one or more of the false acceptance rate and the false rejection rate is based on a context in which the voice data signal was acquired.

8. The method according to claim 7, wherein the context comprises one or more of: a location of an electronic device that acquired the voice data signal; a velocity of the electronic device; an acceleration of the electronic device; a level of noise in the voice data signal; one or more peripheral devices to which the electronic device is connected; and one or more networks to which the electronic device is connected.

9. A biometric authentication system for authentication of a speaker, comprising:
a biometric signal processor, configured to perform a biometric authentication algorithm on a voice data signal, the voice data signal comprising data corresponding to a voice of the speaker, the biometric authentication algorithm comprising a comparison of one or more features in the voice data signal with one or more stored templates corresponding to a voice of an authorised user, and being configured to generate a biometric authentication score;
an input, configured to receive a control signal comprising an indication of one or more of a false acceptance rate and a false rejection rate;
logic circuitry configured to determine the one or more threshold values based on the one or more of the false acceptance rate and the false rejection rate; and
comparison logic, for comparing the biometric authentication score with the one or more thresholds to determine whether the speaker corresponds to the authorised user.

10. The biometric authentication system according to claim 9, wherein the one or more threshold values are based on content within the voice data signal.

11. The biometric authentication system according to claim 9, wherein the biometric authentication system is further configured to initiate a speech recognition algorithm on the voice data signal.

12. The biometric authentication system according to claim 11, wherein the speech recognition algorithm and the biometric authentication algorithm are performed concurrently.

13. The biometric authentication system according to claim 9, further comprising a buffer memory for storing the biometric authentication score.

14. The biometric authentication system according to claim 9, wherein the logic circuitry is further configured to determine the one or more threshold values based on a measure of noise levels in the voice data signal.

15. The biometric authentication system according to claim 9, wherein the indication of one or more threshold values is based on a context in which the voice data signal was acquired.

16. The biometric authentication system according to claim 15, wherein the context comprises one or more of: a location of the biometric authentication system; a velocity of the biometric authentication system; an acceleration of the biometric authentication system; a level of noise in the voice data signal; one or more peripheral devices to which the biometric authentication system is connected; and one or more networks to which the biometric authentication system is connected.

17. An electronic device, comprising:
a biometric authentication system as claimed in claim 9.

18. The electronic device according to claim 17, further comprising:
an application processor coupled to the biometric authentication system.

19. The electronic device according to claim 18, wherein the application processor is configured to generate the control signal comprising the indication of one or more of the false acceptance rate and the false rejection rate.

20. The electronic device according to claim 17, wherein the electronic device is at least one of: a portable device; a battery-powered device; a mobile telephone; an audio player; a video player; a personal digital assistant; a wearable device; a mobile computing platform; a laptop computer; a tablet computer; a games device; a remote control device; a toy; a domestic appliance or controller thereof; a domestic temperature or lighting control system; a security system; and a robot.

21. A method in an electronic device, comprising:
acquiring a voice data signal corresponding to a voice of a user of the electronic device;
initiating a speech recognition algorithm to determine a content of the voice data signal;
determining a security level associated with the content of the voice data signal;
determining a context of the electronic device when the voice data signal was acquired; and
providing an indication of one or more thresholds to a biometric authentication system, for use in determining whether the user is an authorised user of the electronic device,
wherein the indication of one or more thresholds is determined in dependence on the security level associated with the content and the context of the electronic device when the voice data signal was acquired, and
wherein the context is determined in dependence on one or more of: a geographical location of the electronic device; a velocity of the electronic device; an acceleration of the electronic device; a level of noise in the voice data signal; one or more peripheral devices to which the electronic device is connected; and one or more networks to which the electronic device is connected.

22. The method according to claim 21, wherein the content comprises a command, and wherein the security level associated with the content of the voice data signal comprises the security level required to execute the command.

23. The method according to claim 21, wherein one or more of the following apply:
the context is determined in dependence on the geographical location of the electronic device, and wherein determining the context comprises determining whether the electronic device was at a home location of the authorised user when the voice data signal was acquired;
the context is determined in dependence on at least one of the velocity and the acceleration of the electronic device, and wherein determining the context comprises determining whether the electronic device was on vehicular transport when the voice data signal was acquired;
the context is determined in dependence on the level of noise in the voice data signal, and wherein determining the context comprises determining whether the electronic device was in the vicinity of multiple people when the voice data signal was acquired;
the context is determined in dependence on the level of noise in the voice data signal, and wherein determining the context comprises determining whether the electronic device was in a car when the voice data signal was acquired;
the context is determined in dependence on one or more peripheral devices to which the electronic device is connected, and wherein determining the context comprises determining whether the voice data signal was acquired with the peripheral device; and
the context is determined in dependence on one or more networks to which the electronic device is connected, and wherein determining the context comprises determining whether the electronic device is connected to a known network of the authorised user.

24. A signal processor, for use in an electronic device, the signal processor comprising:
an input, configured to receive a voice data signal corresponding to a voice of a user of the electronic device;
a speech recognition interface, for initiating a speech recognition algorithm to determine a content of the voice data signal;
logic circuitry, for determining a security level associated with the content of the voice data signal, and for determining a context of the electronic device when the voice data signal was acquired; and
an output interface, for providing an indication of one or more thresholds to a biometric authentication system, for use in determining whether the user is an authorised user of the electronic device,
wherein the indication of one or more thresholds is determined in dependence on the security level associated with the content and the context of the electronic device when the voice data signal was acquired, and
wherein the context is determined in dependence on one or more of: a geographical location of the electronic device; a velocity of the electronic device; an acceleration of the electronic device; a level of noise in the voice data signal; one or more peripheral devices to which the electronic device is connected; and one or more networks to which the electronic device is connected.

25. The signal processor according to claim 24, wherein the content comprises a command, and wherein the security level associated with the content of the voice data signal comprises the security level required to execute the command.

26. The signal processor according to claim 24, wherein one or more of the following apply:
the context is determined in dependence on the geographical location of the electronic device, and wherein determining the context comprises determining whether the electronic device was at a home location of the authorised user when the voice data signal was acquired;
the context is determined in dependence on at least one of the velocity and the acceleration of the electronic device, and wherein determining the context comprises determining whether the electronic device was on vehicular transport when the voice data signal was acquired;
the context is determined in dependence on the level of noise in the voice data signal, and wherein determining the context comprises determining whether the electronic device was in the vicinity of multiple people when the voice data signal was acquired;
the context is determined in dependence on the level of noise in the voice data signal, and wherein determining the context comprises determining whether the electronic device was in a car when the voice data signal was acquired;
the context is determined in dependence on one or more peripheral devices to which the electronic device is connected, and wherein determining the context comprises determining whether the voice data signal was acquired with the peripheral device; and
the context is determined in dependence on one or more networks to which the electronic device is connected, and wherein determining the context comprises determining whether the electronic device is connected to a known network of the authorised user.

27. An electronic device, comprising:
a signal processor as claimed in claim 24.
